(19) United States
(12) Patent Application Publication
(10) Pub. No.: US 2007/0195910 A1
(43) Pub. Date: Aug. 23, 2007

(54) Transmission system

(75) Inventor: Hideki Shimizu, Nishitokyo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN WATCH CO., LTD., Nishitokyo-shi (JP)

(21) Appl. No.: 10/594,972

(22) PCT Filed: Feb. 18, 2005
(86) PCT No.: PCT/JP05/02566

§ 371 Date: Sep. 29, 2006

(30) Foreign Application Priority Data
Mar. 13, 2004 (JP) 2004-106766

(51) Int. Cl. H04L 27/00

(52) U.S. Cl. 375/299

(57) ABSTRACT

A first transmitter 10 having a first antenna 11 and a power supply part 12, and a second transmitter 20 having a second antenna 21 and a transmitter circuit 22 are provided. The first transmitter 10 and the second transmitter 20 are brought to the state of being connected, and the power supply part 12 of the first transmitter drives the transmitter circuit 22 of the second transmitter 20. Transmission output from the transmitter circuit 22 is simultaneously transmitted from the first antenna 11 provided in the first transmitter 10 and from the second antenna 21 provided in the second transmitter 20. Accordingly, sufficient intensity of transmission radio field is assured. Furthermore, with the configuration where a transmission is made in condition where an instrument and a device for transmitting data are being connected, a favorable transmission can be established even when the radio field intensity is degraded due to a contact by a user.

### TECHNICAL FIELD

The present invention relates to a transmission system, and it is applicable, for example, to a transmission system in which a terminal device or the like manages data measured by various measuring instruments, such as health care instruments.

### BACKGROUND ART

There is known an in-home health caring system, in which health-condition related data measured in ordinary households is collectively managed by a terminal device, so that the in-home health care can be performed, and further the data is transmitted to a remote medical facility via a communication network, so as to carry out health care by a specialist.

There is one example of the aforementioned health caring system, which incorporates a terminal device itself serving as an all-in-one unit having a function of health measuring device, such as a blood-pressure meter and an electrocardiograph. With the configuration in which the terminal device and the health measuring device are integrated as thus described, there is a problem that a user has to go to the place where the terminal device is located, when he or she measures the health condition.

To solve the foregoing problem, another system is also proposed in which the terminal device and the health measuring device are independently provided, and the health measuring device has an infrared communication function, thereby allowing measured data to be inputted into the terminal device remotely.

The in-home health caring system as thus described is able to improve reliability of the health care, as the number of various health measuring devices to be used increases. However, if each of all health measuring devices to be used is provided with a wireless communication function by infrared radiation or radio field, there is a problem that the in-home health caring system may become costly.

In view of above situation, there is proposed a health caring system incorporating a plurality of health measuring devices and one data transfer device, each of the health measuring devices being provided with a storage means which stores measured data, a transmission means which transmits the data being stored to the data transfer device, wherein, the data transfer device reads the data transmitted from the health measuring devices and transmits the data wirelessly to the terminal device, eliminating the need for providing a means of wireless transmission to all of the plurality of health measuring devices, and the data measured by the plurality of health measuring devices is wirelessly transmitted to the terminal device, thereby achieving a low cost (see the Patent Document 1).

FIG. 6 is a diagram showing one configuration example of the foregoing health caring system. In FIG. 6, the health caring system is provided with a measuring instrument 210, data transfer device 220, terminal device 230, and center device 240. The data transfer device 220 collects measured data obtained by various measuring instruments 210 into the terminal device 230, and then, the collected data is transmitted to the center device 240.

The measuring instrument 210 is provided with a measuring means 211, a storing means 212 which stores the measured data, transmitting means 213 which inputs the measured data being stored to the data transfer device 220, and a control means 214 which controls those elements above. The data transfer device 220 is provided with a reading means 221 which reads the measured data transmitted from the measuring instrument 210, a transmitting means 222 which wirelessly transmits the data being read to the terminal device 230, and a control means 223 which controls those elements above. Connection between the transmitting means 213 and the reading means 221 is established by electric connection via communication terminals.

Patent Document 1: Japanese Patent Publication No. 3019084

In the configuration of the health caring system as described above, when the data transfer device wirelessly transmits the measured data obtained by the measuring instrument to the terminal device, the measuring instrument and the data transfer device are physically connected via the communication terminals.

In carrying out the above data transfer operations, if the measuring instrument is a portable type, a user manipulates an operating part such as a button provided on the device while holding the device on his or her hand. When the data transfer operations are carried out in condition where the measuring instrument and the data transfer device are connected, the user is supposed to hold either one of or both the measuring instrument and the data transfer device, which are connected to each other, if the both devices are approximately the same in size.

In this situation, if the user performs the data transfer operations while holding the data transfer device, the device may be covered by the user's hand, or the user may come into contact with at least a part of the data transfer device.

Covering the data transfer device by the user's hand may interfere with propagation of radio field to a receiving position, due to shield effect, the radio field being outputted from the data transfer device. Consequently, field intensity at the receiving position is forced to be degraded. Even when the user's hand does not cover the data transfer device, electrostatic capacity between the user's hand which comes into contact with the data transfer device or the measuring instrument, and an antenna of the data transfer device may change a circuit constant of the transmitter circuit in the data transfer device, thereby changing frequency characteristics in transmission. As a result, the intensity of transmission radio field from the antenna at an intended transmission frequency may result in being degraded.

FIG. 7 includes charts to explain degradation of the field intensity at a predetermined distance from the antenna. FIG. 7A shows a change of field intensity at a predetermined distance from the antenna, and FIG. 7B shows a change of properties in transmission efficiency, obtained from input-output characteristics of the antenna. Here, “f0” indicates a transmission frequency which is set in the transmitter circuit of the data transfer device.

FIG. 7A shows a degradation of the field intensity at a predetermined distance from the antenna. Point c indicates the situation where there is no effect of the user's hand, and point c′ indicates the situation where the data transfer device is covered by the user's hand or the like. Here, it is assumed that the field intensity C1 indicated by the alternate long and short dash line is a minimum field intensity which enables the terminal device to perform receiving. The shield effect produced when the data transfer device is covered interferes with the propagation of radio field outputted from the antenna to the receiving position, causing degradation of the field intensity (from c to c′), and accordingly receiving at the terminal device becomes difficult.

FIG. 7B indicates how the frequency is shifted. The solid line represents the frequency characteristics held by the data transfer device, and the dashed line represents the frequency characteristics that have been shifted by an electrostatic capacity between the user's hand and the antenna. Due to the shift of the frequency characteristics, the transmission efficiency at frequency f0 falls from b to b′, thereby degrading the intensity of the transmission radio field at frequency f0 outputted from the antenna. As a result, the field intensity at a predetermined distance from the antenna is also degraded similar to the case of shield effect, causing a problem that transmission is not made favorably.

It is conceivable that the foregoing problem can be solved by setting the radio field intensity from the antenna of the data transfer device at a higher level. However, an upper limit of the intensity of transmission radio field is stipulated by the Radio Regulation. If transmission is made by holding the measuring instrument side, the field intensity at a predetermined distance from the antenna may go over the prescribed value. Therefore, this means for solving the problem cannot be adopted.

In general, there is known a communication device which is provided with a built-in antenna and an external antenna, and these antennas are switched to make a transmission. It is also conceivable that this antenna switching mechanism is applied to a configuration in which transmission is made while the measuring instrument and the data transfer device are connected to each other. However, even with a configuration in which an antenna is provided also on the measuring instrument side and both antennas are switched to make a transmission, if an instrument or a device on the side of switched antenna is covered by hand, it may interfere with propagation of the transmission radio field from the antenna, and further, the frequency characteristics of both antennas may be varied due to the contact by the user. Therefore, the intensity of the transmission radio field is degraded and favorable transmission status cannot be expected.

Considering the situation above, the present invention aims to solve the conventional problems, and to assure a sufficient intensity of transmission radio field. More specifically, the present invention aims to achieve a favorable transmission, even when a user's contact degrades the radio field intensity or interferes with the propagation thereof, in the configuration where the transmission is made by using an instrument and a data transmission device, which are connected to each other.

### SUMMARY OF THE INVENTION

According to the present invention, a transmission is made in a condition where two devices, such as a measuring instrument and a data transfer device, are combined, and even if a contact by a user degrades the radio field intensity or interferes with a propagation of the radio field to a receiver, the transmission is made simultaneously from the two devices to output transmission radio field from the antennas, which has sufficient intensity for receiving, and thereby it is possible to achieve a favorable transmission.

In particular, the present invention is directed to a configuration which allows an output of transmission radio field with sufficient intensity for receiving, even in any of the following cases: transmission from any one of the devices is disabled; the intensity of the transmission radio field from the antennas of both the devices is simultaneously degraded; or a propagation of the radio field to the receiver is disturbed.

The present invention includes an embodiment of transmission system which incorporates a combination of a first transmitter and a second transmitter.

One embodiment of the transmission system according to the present invention is a configuration which is provided with the first transmitter having a first antenna, and the second transmitter having a second antenna. In this configuration, it is assumed that the first transmitter and the second transmitter are in state of being connected, and the first antenna and the second antenna simultaneously transmit identical information.

In addition, the first transmitter has a configuration being provided with a power supply part, and in the state of being connected, the power supply part is connected to the second transmitter, whereby the identical information is simultaneously transmitted from the first antenna and the second antenna.

With the configuration above, the simultaneous transmission from the first transmitter and from the second transmitter is executed. Accordingly, even in a situation where transmission from any one of the first and the second transmitters is disabled or a transmitted output is degraded, due to a user's approaching, touching, or the like, the other transmitter is able to make a transmission, thereby assuring a favorable communication status.

In addition, the first transmitter is provided with an operating means to carry out a transmitting operation, and the radio field intensity outputted from the first antenna is set higher than the radio field intensity outputted from the second antenna. With the configuration, no matter how a user or the like comes into contact with the first transmitter and the second transmitter being connected, it is possible for the antennas to output transmission radio field with sufficient intensity for receiving.

For example, if a transmission is disabled from one transmitter because the user holds it by hand or the like, the other transmitter is able to make a transmission. For the case where the radio field intensity from the first and the second transmitters are both degraded or the propagation of the radio field is disturbed because the user holds both transmitters by hand, since the radio field intensity outputted from the first antenna is set higher, it is possible to output radio field with sufficient intensity for receiving, even after being degraded.

Here, following is a reason why the radio field intensity outputted from the first antenna is set higher: since the first transmitter is provided with an operating means to carry out transmission operations, the user is in contact with or approaching the first transmitter when the radio field are transmitted, and thus the radio field intensity outputted from the first transmitter may be degraded or the radio field to the receiver may be disturbed. Accordingly, by setting the radio field intensity from the first antenna higher, it is possible to obtain a sufficient receiving intensity even when the radio field intensity is degraded or the radio field to the receiver is disturbed.

On the other hand, if the radio field intensity outputted from the second antenna is set higher, there is a possibility that the radio field is transmitted from the second transmitter without reducing the intensity. Therefore, at a predetermined distance from the antenna, it might exceed the field intensity which is stipulated by the Radio regulation.

Therefore, by setting the radio field intensity outputted from the first antenna higher, it is possible to output radio field intensity sufficient for receiving, without exceeding the field intensity as stipulated by the Radio regulation, even when the first transmitter and the second transmitter in the state of being connected are used in a similar manner.

The first antenna and/or the second antenna may be a loop antenna. Forming the first antenna as a loop antenna may facilitate setting of a higher transmission radio field intensity, by taking up a large loop area of the loop antenna, or the like.

In addition, the first transmitter is provided with a biometric function means, which measures biometric information. The biometric means transmits measured data to the transmitter circuit provided in the second transmitter in condition where connection is established between the first transmitter and the second transmitter. Accordingly, the first transmitter and the second transmitter are allowed to transmit the measured data simultaneously.

The second transmitter is connected to each of multiple measuring machines for measuring biometric information, which is different from the information measured by the first transmitter, and the biometric information measured by the connected measuring machines is transmitted from the second antenna. The first transmitter may be designed in such a manner that it is freely incorporated in any of multiple types of biometric devices, and the second transmitter is detachable from and attachable to each of the biometric devices. With thus configured, the second transmitter is applicable to any of the multiple types of biometric devices. By mounting the second transmitter on a target biometric device, the second transmitter is allowed to be connected to the first transmitter incorporated in the target biometric device, and thereby it is possible to transmit measured data obtained by the biometric device, simultaneously from the first and the second antennas. The biometric device may be a pedometer, for example. In addition, as a biometric device, the present invention may also be applied to a blood-pressure meter, clinical thermometer, a weighing machine, an electrocardiograph, a blood sugar level meter, or the like.

According to the present invention, it is possible to assure sufficient radio field intensity. In the configuration where a transmission is made in condition where an instrument and a device for transmitting the data are connected, it is possible to make a favorable transmission even when the radio field intensity is degraded due to a contact by a user.

In addition, the transmission system according to the present invention makes a transmission in condition where the first transmitter and the second transmitter are connected, or in condition where a main unit of an electric instrument and a portable terminal device, and a transmission adapter are connected, and in this status, simultaneous transmission is made from two antennas respectively provided on both devices being connected, thereby assuring a favorable transmission state.

### BRIEF DESCRIPTION OF THE DRAWINGS

FIG. 1 is a diagram to explain an overview of the present invention.

FIG. 2 is a diagram to explain a configuration example of the first transmitter and the second transmitter according to the present invention.

FIG. 3 includes illustrations to explain a relationship among the first transmitter, the second transmitter, and a user, according to the present invention.

FIG. 4 includes charts to explain field intensity at a predetermined distance from each antenna according to the present invention.

FIG. 5 includes charts to explain field intensity at a predetermined distance from each antenna, according to the present invention.

FIG. 6 is a diagram showing one configuration example of a conventional health caring system.

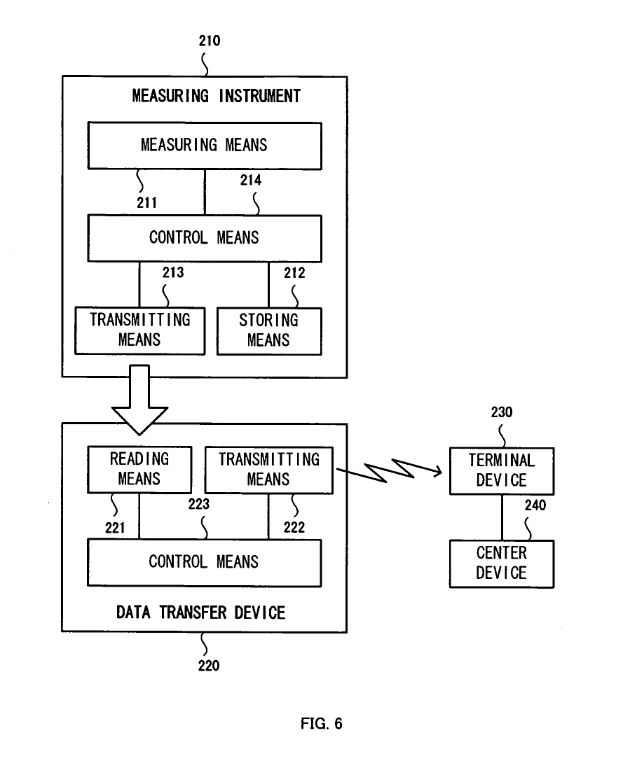

FIG. 7 includes charts to explain degradation of the field intensity at a predetermined distance from an antenna.

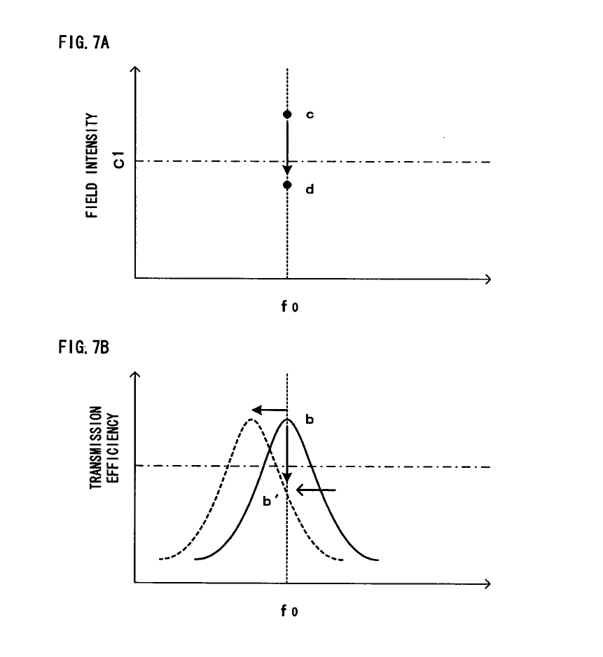

### PREFERRED EMBODIMENTS OF THE INVENTION

A transmission system according to the present invention will be explained in detail with reference to the accompanying drawings.

The transmission system according to the present invention is provided with a first transmitter serving as a source for transmitting data and a second transmitter corresponding to a transmission adapter, and the transmission system incorporates an electric instrument having a biometric function, which corresponds to the first transmitter.

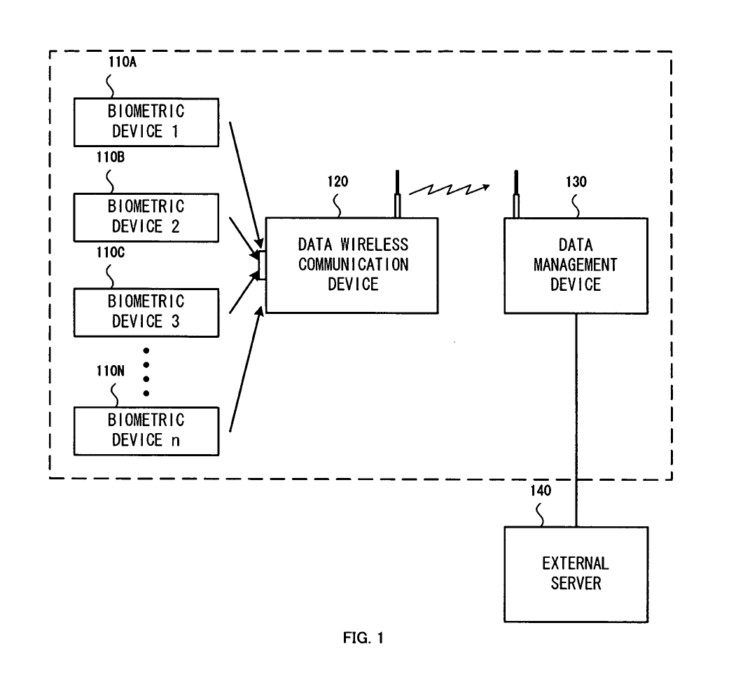

FIG. 1 is a diagram to explain an overview of the present invention, taking an electric instrument such as a health care instrument having the biometric means, as a way of example.

There is shown a configuration of transmission system according to the present invention when healthcare is performed by using multiple types of and/or a plurality of health care instruments (hereinafter, referred to as biometric devices 110), within an area limited to a certain degree (the range indicated by the dashed line in FIG. 1), such as in-home, a hospital, a health clinic, and a care facility.

In the transmission system according to the present invention, the healthcare is performed by using the biometric devices 110A to 110N. The biometric devices 110A to 110N are, for example, multiple types of health care instruments, such as a pedometer, a blood-pressure meter, a clinical thermometer, a weighing machine, an electrocardiograph, and a blood sugar level meter, and a large number of health care instruments of the same kind or of different kinds are included.

The transmission system is provided with a data wireless communication device 120 and a data management device 130, which are usable for each of the biometric devices 110A to 110N. The data wireless communication device 120 serves as a data transferring means which collects measured data obtained by each of the biometric devices 110A to 110N, and wirelessly transfers the measured data to the data management device 130. At least one data wireless communication device 120 is prepared for the biometric devices 110A to 110N, and the data wireless communication device 120 is sequentially connected to each of the biometric devices 110A to 110N, in repeating manner, thereby allowing the communication device to be used by any of the biometric devices. It is to be noted that the number of the data wireless communication device 120 is not limited to one. A plurality of data wireless communication devices 120 may be employed.

In the present invention, each of the biometric devices 110A to 110N corresponds to the first transmitter, and the data wireless communication device 120 corresponds to the second transmitter. Combination of this first transmitter and the second transmitter constitutes the transmission system, data obtained by the first transmitter is sent from the antennas mounted on the first transmitter and from the second transmitter respectively, to the data management device 130, and the data is collectively managed therein.

The data from each of the biometric devices 110A to 110N having been sent to the data management device 130 is transferred to an external server 140. When the transmission system is implemented in home, the external server 140 may be provided at a hospital, a clinic center, or the like. Alternatively, if the transmission system is implemented within a facility such as a hospital, the external server may be provided in an outside data management center or the like.

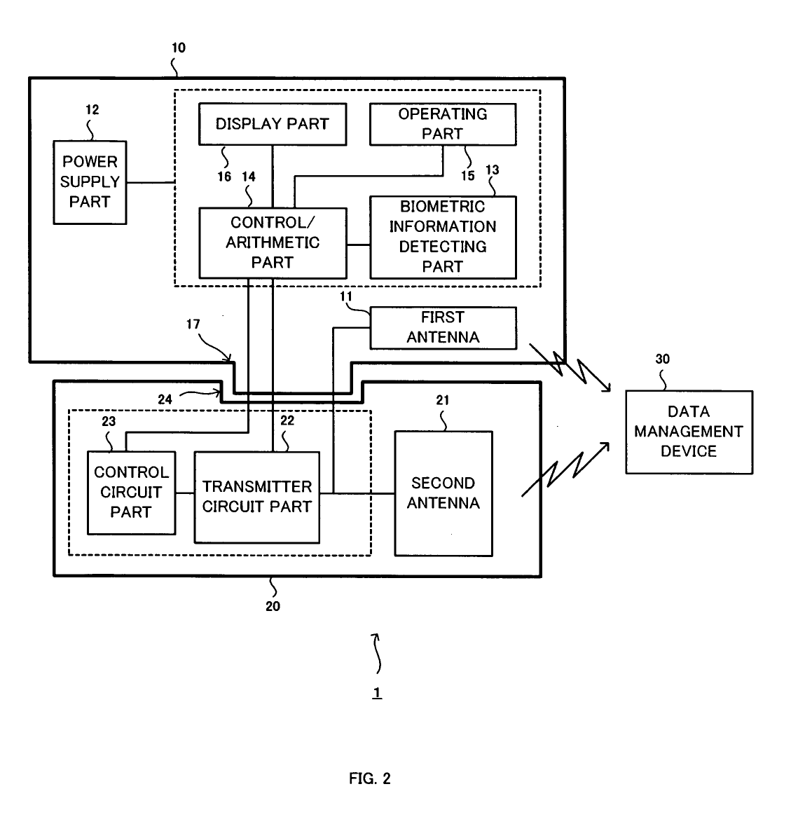

FIG. 2 shows a configuration example of the first transmitter and the second transmitter according to the present invention.

The transmission system 1 according to the present invention incorporates the first transmitter 10 and the second transmitter 20, and transmits data to the data management device 30. The data management device 30 collectively manages the data thus transmitted. It is to be noted here that the first transmitter 10 and the second transmitter 20, and the data management device 30 as shown in FIG. 2 correspond to the biometric devices 110A to 110N, the data wireless communication device 120, and the data management device 130 as shown in FIG. 1, respectively.

The first transmitter 10 is provided with; a first antenna 11, power supply part 12, biometric information detecting part 13, control/arithmetic part 14, operating part 15, and display part 16.

The power supply part 12 serves as a driving source for driving the biometric information detecting part 13, control/arithmetic part 14, operating part 15, display part 16, and the like, as well as a driving source for driving the second transmitter 20. The area surrounded by the dashed line within the first transmitter 10 corresponds to various functional elements to be executed on the first transmitter side, and the biometric information detecting part 13, control/arithmetic part 14, operating part 15, and display part 16 represent one configuration example of these functional elements. For instance, this configuration can be applied to functions for measuring biometric information, such as a pedometer, a blood-pressure meter, a clinical thermometer, a weighing machine, an electrocardiograph, and blood sugar level meter. The biometric information detecting part 13 is an element to measure those biometric information items by using a sensor appropriate for each measuring target so as to detect data, and the display part 16 is an element to display measured results, guidance for measurement, and the like. The operating part 15 is an element to receive an input of measuring operation and to conduct an operation for transmitting measured data, and the like, and the control/arithmetic part 14 performs controls and/or arithmetic operations for the measuring process, transmitting process, displaying process, and the like.

The first transmitter 10 is provided with the first antenna 11 as a mechanism for transmission. The first transmitter 10 is capable of sending a transmission signal from the first antenna 11. However, since the first transmitter 10 is not provided with a transmitter circuit, transmission cannot be carried out by the first transmitter 10 only. The first transmitter 10 makes a transmission in receipt of a transmission output from the transmitter circuit part 22 provided in the second transmitter 20, which will be described below.

On the other hand, the second transmitter 20 is provided with the second antenna 21, transmitter circuit part 22, and control circuit part 23.

The transmitter circuit part 22 obtains transmission data from the first transmitter 10, forms a transmission signal, and outputs the transmission signal to the second antenna 21 provided in the second transmitter 20. At the same time, the transmitter circuit part 22 outputs the transmission signal to the first antenna 11 provided in the first transmitter 10, and the same transmission signal is transmitted from the second antenna 21 and the first antenna 11 simultaneously.

The control circuit part 23 receives a control signal from the control/arithmetic part 14 in the first transmitter 10, and controls actions of the transmitter circuit 22.

The second transmitter 20 is provided with the transmitter circuit part 22 and the second antenna 21 as a mechanism for transmission. The second transmitter 20 is capable of transmitting data from this transmitter circuit part 22 and the second antenna 21. However, since the second transmitter 20 is not provided with a power supply part, the second transmitter 20 is not capable of transmitting data by itself. The second transmitter 20 receives power supply from the power supply part 12 provided in the first transmitter 10, drives the transmitter circuit part 22 and the control circuit part 23, and then sends a formed transmission signal from the second antenna 21 mounted on itself, as well as transferring the signal to the first transmitter 10 so as to send the signal also from the first antenna 11.

In addition, the second transmitter 20 is detachable from and attachable to the first transmitter 10, and when the second transmitter 20 is attached to the first transmitter 10, both of the transmitters 10, 20 are electrically connected. The first transmitter 10 and the second transmitter 20 are respectively provided with connector parts 17, 24, as a mechanism to establish electrical connection and physical connection, in detachable and attachable manner.

The connector parts 17, 24 are detachable from and attachable to each other, and physical connection therebetween establishes electrical connection. With this electrical connection, power is supplied from the first transmitter 10 to the second transmitter 20, and the transmission data is also transferred, such as biometric information detected by the biometric information detecting part 13. On the other hand, a transmission signal formed in the transmitter circuit part 22 is transferred from the second transmitter 20 to the first transmitter 10.

With the configuration above, the transmission system 1 is allowed to make a simultaneous transmission of an identical signal, from the first antenna 11 mounted on the first transmitter 10 and from the second antenna 21 mounted on the second transmitter 20.

Here, the radio field intensity outputted from the first antenna 11 is set higher than the radio field intensity outputted from the second antenna 21, but it is also possible to configure such that the radio field intensity outputted from the first antenna 11 and that from the second antenna 21 are set to an equivalent level.

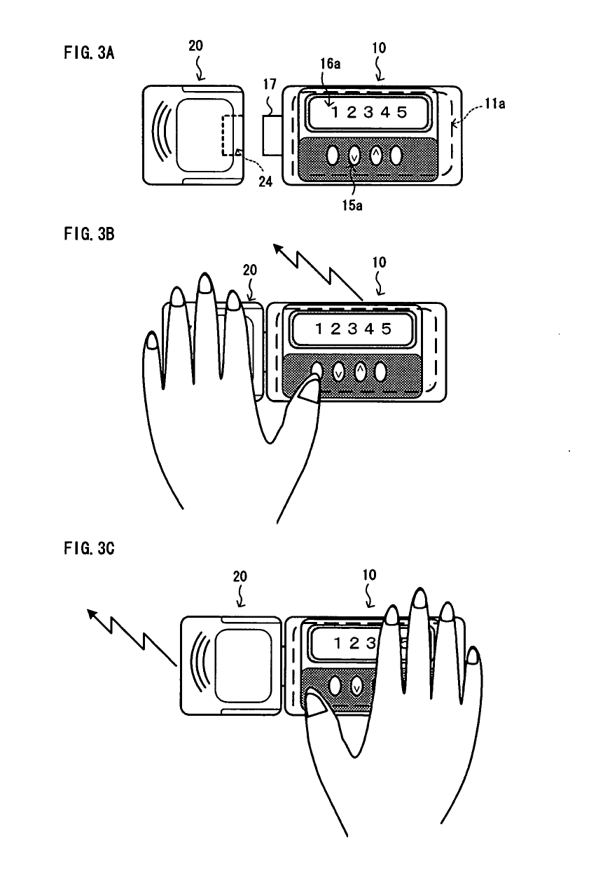

Next, with reference to FIG. 3 to FIG. 5, explanations will be made regarding the intensity of transmission radio field outputted from each of the antennas respectively provided on the first transmitter and the second transmitter, according to the present invention.

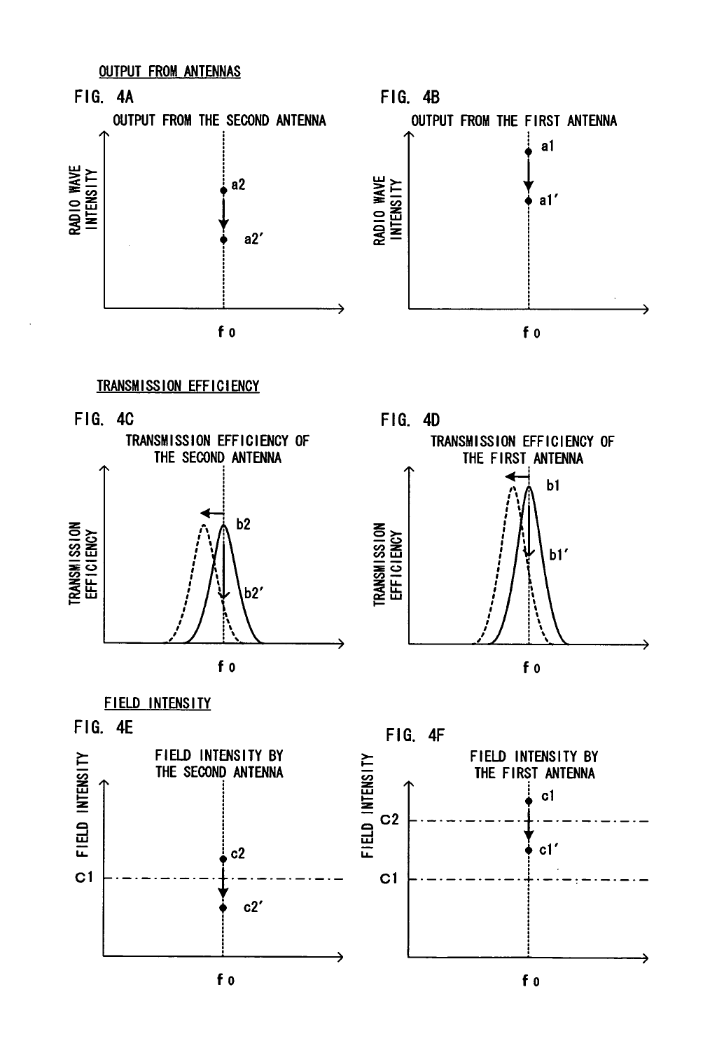

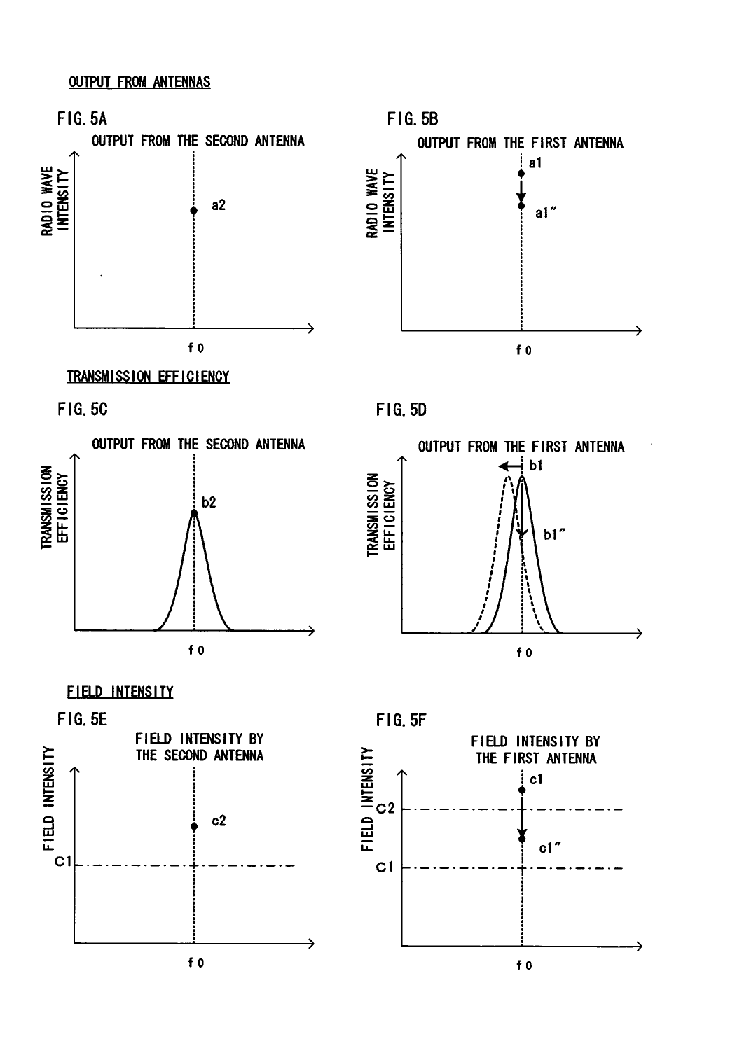

FIG. 3 includes illustrations to explain the relationship among the first transmitter, the second transmitter, and the user. FIG. 4 and FIG. 5 include charts to explain the field intensity at a predetermined distance from each antenna, for every case as shown in FIG. 3.

In FIG. 3A, the transmission system 1 is provided with the first transmitter 10 and the second transmitter 20. Here, a pedometer is employed as an example of the first transmitter 10. The pedometer is an instrument that counts each step of a user. It is further possible to provide a function to calculate derived data such as consumed calorie and a distance the user has covered on foot, on the basis of thus counted number of steps.

Various data items such as the number of steps, consumed calorie, and a distance covered on foot, which have been obtained by the measurement, are displayed on the display panel 16a. In addition, reference numeral 15a indicates operation buttons to select and execute an operation, among the operations such as a change of measuring mode, an input of setting values such as height, weight, and age, and a transmission processing.

In addition, inside the main body of the first transmitter 10, there are provided the aforementioned configuration incorporating the power supply part 12, biometric information detecting part 13, and control/arithmetic part 14, and the like, and the first antenna 11 such as loop antenna 11a (indicated by dashed line) is also provided.

The second transmitter 20 constitutes a data transfer device, and incorporates the aforementioned second antenna 21, transmitter circuit part 22, and control circuit part 23 within the case.

Furthermore, the first transmitter 10 is provided with the connector 17, and the second transmitter 20 is provided with the connector 24. By joining these connectors 17, 24, the first transmitter 10 and the second transmitter 20 are coupled, and electronic circuit connection is established within both transmitters.

FIG. 3A shows a situation, in which the first transmitter 10 and the second transmitter 20 are not connected yet, and FIG. 3B, FIG. 3C each shows a situation in which the first transmitter 10 and the second transmitter 20 are coupled to each other. Transmission is made while the first transmitter 10 and the second transmitter 20 are in a state of being connected.

Usually, the user carries out transmission operations while holding by hand the first transmitter 10 and the second transmitter 20 being coupled to each other. In doing so, the user is supposed to hold by hand either one of the first transmitter 10 and the second transmitter 20 being coupled.

FIG. 3B shows a situation in which the user is in contact with the second transmitter 20 side, and FIG. 3C shows a situation in which the user is in contact with the first transmitter 10 side.

Firstly, as shown in FIG. 3B, the situation in which the user is in contact with the second transmitter 20 side will be explained.

FIG. 4 includes charts each showing a change of the radio field intensity outputted from each antenna, a change of transmission efficiency of each antenna, and a change of field intensity at a predetermined distance from each antenna, when the user comes into contact with the second transmitter 20 side as shown in FIG. 3B. FIGS. 4A and 4B indicate a change of transmission radio field intensity outputted from each antenna. FIGS. 4C and 4D indicate a change of properties in transmission efficiency obtained from input/output characteristics of each antenna, and FIGS. 4E and 4F indicate a change of field intensity at a predetermined distance from each antenna.

Firstly, an explanation will be made, with reference to FIGS. 4C and 4D, regarding the status in which the radio field intensity outputted from each of the first and the second antennas is degraded due to the effect of the hand which is holding the transmitter 20.

As shown in FIG. 3B, when the user's hand holds the second transmitter 20, the properties in transmission efficiency from the second antenna are changed from b2 (indicated by a solid line) to b2′ (indicated by a dashed line), as shown in FIG. 4C, due to the effect of electrostatic capacity between the hand holding the second transmitter 20 and the antenna.

Before the user holds the transmitter 20, the transmission efficiency has reached a peak at frequency f0, but when the user holds the transmitter by hand, the peak is deviated from f0. Therefore, the transmission efficiency at a target frequency f0 is degraded. As a result, the intensity of the transmission radio field at frequency f0, which are outputted from the second antenna, is degraded from a2 to a2′ as shown in FIG. 4A.

On the other hand, as for the first transmitter 10, when the second transmitter 20 is held by the user's hand as shown in FIG. 3B, the properties in transmission efficiency from the first antenna is changed due to the effect of electrostatic capacity between fingers operating the first transmitter and the first antenna. Then, as shown in FIG. 4D, the transmission efficiency at the target transmission frequency f0 falls from b1 (indicated by a solid line) to b1′ (indicated by a dashed line). As a result, the radio field intensity at the frequency f0 outputted from the first antenna is degraded from a1 to a1′ as shown in FIG. 4B.

Next, a situation will be explained, in which the radio field from the first and the second antennas, the intensity thereof having been degraded to a1′ and a2′, will be further disturbed by the effect of the hand that holds the transmitter 20.

When the second transmitter is held by the user's hand, this hand holding the second transmitter covers the antenna, and because of shield effect, propagation of the transmission radio field having intensity a2′ from the second antenna to a receiving position is disturbed. Consequently, the field intensity at the receiving position is degraded.

On the other hand, as for the first transmitter, when the user's hand holds the second transmitter 20 as shown in FIG. 3B, a part of the antenna is covered by fingers that operate the first transmitter, and because of shield effect, propagation of the radio field intensity a1′ from the first antenna to the receiving position is disturbed. Consequently, the field intensity at the receiving position is degraded.

FIGS. 4E and 4F show a change of field intensity at a predetermined distance from each antenna, as to the radio field outputted from the second antenna and the first antenna respectively.

As described above, the transmission radio field outputted from the second transmitter is degraded in intensity because of the electrostatic capacity between the hand and the antenna, and further, due to the coverage by the hand, the propagation of the radio field is disturbed. Therefore, the field intensity at a predetermined distance from the antenna is reduced from c2 to c2′. Here, when the field intensity required for favorable receiving at the receiving side is assumed as C1, the field intensity c2′ becomes equal to or less than the allowable field intensity C1. Therefore, it is not possible to expect a favorable receiving.

On the other hand, as described above, the radio field outputted from the first transmitter falls from c1 to c1′ as shown in FIG. 4F due to the degradation of intensity and disturbance of propagation. When the field intensity as stipulated by the Radio regulation is assumed as C2, the field intensity becomes equal to or less than the field intensity C2 being prescribed, since it is degraded from c1 to c1′. Therefore, it fits under the limit of the value stipulated by the Radio regulation. In addition, the intensity of the transmission radio field outputted from the first antenna is set higher than that of the transmission radio field outputted from the second antenna. Accordingly, it is possible to make the intensity from the first antenna equal to or higher than the allowable field intensity C1, even when the field intensity at a predetermined distance from the antenna is degraded to c1′, thereby enabling a favorable receiving.

FIG. 5 includes charts showing the situations where the user comes into contact with the first transmitter side as shown in FIG. 3C; a change of intensity of transmission radio field outputted from each antenna, a change of transmission efficiency from each antenna, a change of field intensity at a predetermined distance from each antenna. FIGS. 5A and 5B indicate a change of intensity of transmission radio field outputted from each antenna, FIGS. 5C and 5D indicate a change of properties in transmission efficiency obtained from input/output characteristics of each antenna, and FIGS. 5E and 5F indicate a change of field intensity at a predetermined distance from each antenna.

Firstly, there will be explained a change of the radio field intensity outputted from the first and the second antennas due to holding of the first transmitter 10 by the user's hand. When the user holds the first transmitter 10 by hand as shown in FIG. 3C, since electrostatic capacity is not generated between the hand holding the first transmitter 10 and the second antenna, properties in the transmission efficiency from the second antenna do not change as shown in FIG. 5C. Therefore, the transmission efficiency at frequency f0 stays b2.

Therefore, even when the user holds the transmitter 10 by hand, the intensity of the transmission radio field at the frequency f0 outputted from the second antenna does not change from a2 as shown in FIG. 5A.

On the other hand, as for the first transmitter 10, when the user holds the first transmitter 10 as shown in FIG. 3C, the properties in transmission efficiency from the first antenna are changed due to the effect from the electrostatic capacity between the hand holding the first transmitter or fingers for operation and the antenna. Therefore, the transmission efficiency at the target frequency f0 falls from b1 (indicated by a solid line) to b1″ (indicated by a dashed line) as shown in FIG. 5D. Consequently, the radio field intensity at frequency f0 outputted from the first antenna is degraded from a1 to a1″ as shown in FIG. 5B.

Next, with respect to the transmission radio field from the first and the second antennas, an effect by covering the antennas by hand will be explained.

Even if the first transmitter is held by a user's hand, the second antenna is not covered by the hand. Therefore, the propagation of the transmission radio field with the intensity a2, from the second antenna to the receiving position, is not disturbed.

On the other hand, as for the first transmitter, when the user holds the first transmitter by hand, the first antenna is covered by the hand holding the transmitter. Therefore, due to the shield effect, the propagation of the radio field with intensity a1″ from the first antenna to the receiving position is disturbed. Consequently, the field intensity at the receiving position is degraded.

FIGS. 5E and 5F each indicates a change of field intensity at a predetermined distance from the antennas, according to the radio field outputted from the second antenna and the first antenna respectively.

As described above, the transmission radio field outputted from the second transmitter is not influenced by the hand. Therefore, when the field intensity required for favorable receiving at the receiving side is assumed as C1, the radio field intensity stays c2 which is higher than C1, and thus enabling a favorable receiving.

On the other hand, as mentioned above, the radio field intensity outputted from the first transmitter falls from c1 to c1″ as shown in FIG. 5F, due to the intensity degradation and the disturbance of the propagation. Therefore, the radio field intensity outputted from the first transmitter becomes equal to or less than the field intensity C2 which is stipulated by the Radio regulation, thereby fitting into the prescribed value range. In addition, the transmission radio field intensity outputted from the first antenna is set higher than the transmission radio field intensity outputted from the second antenna. With this configuration, even when the field intensity at a predetermined distance from the antenna is degraded to the field intensity c1″, it is still equal to or higher than the allowable field intensity C1, and thus it is possible to achieve a favorable receiving.

As described above, the radio field intensity outputted from the first antenna is set higher than the radio field intensity outputted from the second antenna, and transmission is made from the both antennas simultaneously. With this configuration, even when the transmitting operation is performed while holding any one of the first transmitter and the second transmitter being coupled, it is possible to output transmission signals with sufficient intensity for receiving.

According to the present invention, a built-in antenna is provided in some types of health care instruments among multiple health care instruments, in which transmission radio field from the second antenna of the second transmitter are degraded. With this configuration, the data wireless communication device is usable for any type of the multiple health care instruments.

For instance, the multiple health care instruments include a pedometer, a weighing machine, and other health care instruments (blood-pressure meter, body-fat meter, and the like). If the second transmitter is mounted on the pedometer or the weighing machine, the transmission radio field from the second antenna may be degraded and/or the propagation of the radio field may be disturbed. On the other hand, when the second transmitter is mounted on any other health care instruments, the transmission radio field from the second antenna may not be degraded, nor the propagation may not be disturbed. In such a case above, as for the pedometer and the weighing machine, it is necessary to use a transmitter which is capable of transmitting from the antenna, transmission radio field with intensity higher than the intensity for the other health care instruments. As thus described, a transmitter which is capable of transmitting radio field with higher intensity should be used for the pedometer and weighing machine, and a transmitter which is capable of transmitting radio field with lower intensity should be used for the other instruments. Therefore, for the pedometer and the weighing machine, it is not possible to use a transmitter which is commonly utilized for all the other health care instruments.

Here, according to the present invention, the first antenna is built in the pedometer or the weighing machine, and the intensity of transmission radio field are adjusted to the level suitable for those instruments. With this configuration, it is possible to make a data transmission by using the same transmitter as the one used for the blood-pressure meter or blood-fat meter. Accordingly, one transmitter is applicable for all of the multiple health care instruments.

As for the weighing machine, there is a possibility that a receiver is not able to receive the radio field transmitted from the second antenna of the second transmitter that is mounted on the weighing machine. For instance, the weighing machine is usually structured in such a manner that mechanical and electrical components are built in a metallic thin box shaped enclosure. Therefore, in the condition where the transmitter is mounted, the transmitter and the metallic enclosure and/or metallic components may approach each other. Then, such metallic enclosure and metallic components may disturb the magnetic field and electric field around the antenna of the transmitter, and the directivity of the radio field transmitted from the transmitter may be changed. As a result, even if the radio field with desired transmission intensity is outputted from the antenna of the transmitter, the radio field may not reach the receiving position at a predetermined distance, and the field intensity at the receiving position may become weak.

Generally, the weighing machine is placed on a floor for measurement. Therefore, in the condition where it is placed on the floor with the transmitter being mounted, the antenna of the transmitter is positioned in such a manner as approaching the floor. In the situation just described, if the floor is made of metal, a condenser is formed between the antenna and the floor, and an electrostatic capacity is held therebetween. The situation above changes properties in transmission efficiency, and the peak of the efficiency may be displaced from the transmission frequency f0 having been set, thereby degrading the intensity of the transmission radio field from the antenna.

Furthermore, the antenna may be covered by the metallic enclosure depending on the positional relationship between the transmitter and the metallic enclosure. Therefore, due to the shield effect by the metallic enclosure, the propagation of the radio field outputted from the data transfer device to the receiving position may be disturbed. Consequently, the field intensity at the receiving position may be degraded.

For the reasons stated above, if a target instrument is a weighing machine, there is a possibility that the radio field transmitted from the weighing machine cannot be received by the receiver. However, by applying the present invention to incorporate an antenna in the weighing machine, sufficiently high field intensity can be obtained at the receiving position. In particular, when the target instrument is a weighing machine, it is possible to form an antenna with a large loop to produce high transmission efficiency, because the weighing machine is larger in size than the pedometer. Therefore, even if it is structured in such a manner as covered by a metallic enclosure, it is possible to make a transmission with radio field of intensity sufficient for receiving, by the loop antenna provided within the weighing machine.

In the above descriptions, a pedometer and a weighing machine have been taken as examples. However, the present invention is not limitedly applied to the pedometer and the weighing machine, but it can also be applied to other health care instruments such as a blood-pressure meter, a clinical thermometer, an electrocardiograph, and blood sugar level meter.

In addition, the present invention can also be applied to electric equipment or portable terminal equipment which transmits arbitrary information, without restricting to the devices having a biometric function.

In the embodiments of the present invention, the first transmitter is configured such that a transmitter circuit is not provided, and the second transmitter and a corresponding transmission adapter are not provided with a power supply part. With thus structured, there is an effect that the configuration can be simplified. In addition, there is another effect that the second transmitter or the transmission adapter is usable for any of the multiple first transmitters.

In particular, in the situation where the health care is performed within a limited area such as in home, hospital, clinic, care facility, and the like, and measured data from various types and a larger number of health care instruments, such as a pedometer, blood-pressure meter, clinical thermometer, weighing machine, electrocardiograph, and blood sugar level meter, is collectively managed, a small number of second transmitters or transmission adapters are allowed to be applied and connected to any one of the health care instruments. With this configuration, it is not necessary to provide a second transmitter or a transmission adapter for every health care instrument, and costs for each health care instrument can be reduced.

### INDUSTRIAL APPLICABILITY

The present invention is applicable to electric instrument or portable terminal equipment which transmits inputted information, as well as a health care instrument such as a pedometer, blood-pressure meter, clinical thermometer, weighing machine, electrocardiograph, and blood sugar level meter.

1. A transmission system comprising,
a first transmitter having a first antenna and
a second transmitter having a second antenna, wherein,
said first transmitter further comprises a power supply part,
said second transmitter comprises a transmitter circuit which outputs identical information as a transmission signal to said first antenna and said second antenna,
said second transmitter is attachable to and detachable from said first transmitter, and
in a state where said first transmitter and said second transmitter are connected, said second transmitter is connected to said power supply part, and said first antenna and said second antenna simultaneously transmit said identical information.

2. (canceled)

3. The transmission system according to claim 1, wherein,
said first transmitter comprises an operating means which conducts a transmitting operation, and radio field intensity outputted from said first antenna is set higher than the radio field intensity outputted from said second antenna.

4. The transmission system according to either of claim 1 and claim 3, wherein,
said first antenna and/or said second antenna is a loop antenna.

5. (canceled)

6. The transmission system according to claim 1, wherein,
said first antenna has a biometric function to measure biometric information, and said identical information is said biometric information.

7. The transmission system according to claim 6, wherein,
said second transmitter is connected to each of multiple measuring machines to measure biometric information which is different from the information of said first transmitter, and the biometric information measured by said measuring machines being connected is transmitted from said second antenna.

8. The transmission system according to either of claim 6 and claim 7, wherein,
said biometric information is the number of steps.

9. (canceled)
